(19) United States
(12) Patent Application Publication
(10) Pub. No.: US 2004/0084804 A1
(43) Pub. Date: May 6, 2004

(54) Continuous process for the preparation of absorbable articles and the use thereof

(76) Inventor: Amy T. Jonn, Raleigh, NC (US)

Correspondence Address: Amy Jonn, 2308 Wakefield Plantation Dr., Raleigh, NC, 27614, US

(21) Appl. No.: 10/425,058

(22) Filed: Apr. 28, 2003

Related U.S. Application Data
(60) Provisional application No. 60/379,533, filed on May 10, 2002.

(51) Int. Cl. B29C 47/78

(52) U.S. Cl. 264/211.24; 264/319; 264/328.1

(57) ABSTRACT

A continuous process for the preparation of absorbable polymers and their processing into articles is disclosed. The process comprises a reactive extrusion step where cyclic monomers and other additives are polymerized into absorbable homopolymer or copolymer compositions, which are then extruded continuously and molded into desirable articles using regular molding techniques.

This invention describes a continuous process for the preparation of absorbable articles and the use thereof.

Absorbable polymeric materials, especially polyesters based on hydroxy-carboxylic acids, have been used increasingly in surgical, pharmaceutical, medical and other industrial fields. Devices made form these materials for surgical, pharmaceutical or medical use include sutures, clips, clamps, plates, pins, rods, anchors, matrixes for delivering pharmaceutical agents and support for tissue engineering.

Processes for the preparation of above-mentioned devices are well known in the art. Absorbable polymers are usually synthesized in relatively small quantities by a process known as batch operation. These materials are then processed into surgical/medical devices by a thermal treatment, such as melt extrusion followed by orientation to achieve certain degrees of crystallinity, or injection molding. There are several essential disadvantages in this manufacturing process. First of all, the batch polymerizations result into variations among the batches of the materials, which can cause tremendous difficulties in following steps of processing and consequently, poor control of the quality of the products. Secondly, the batch polymerizations require extended processing time, including preparing each batch of polymerization reaction, cleaning the reactor afterwards, post-treating the polymers and extensive testing necessary for the quality controls. Thirdly, processing of these polymers into desired articles is also time-consuming associated with all the steps of materials handling processes. Fourthly, the production yield of the batch operation is usually low. And finally, the batch operation to manufacture absorbable articles usually requires a second heat treatment of the absorbable materials, such as melt injection molding, where extreme care has to be taken because these absorbable polymers are highly sensitive to environmental moisture for thermal degradation. Even under carefully selected conditions, some degrees of thermal degradation are still unavoidable. It is not uncommon that these absorbable polymers loose 20% of their original viscosity after the thermal processing. Although some efforts of preparing absorbable polymers in a continuous manner have been attempted, a completely continuous process for the preparation of surgical/medical devices, such as molded parts, directly from a continuous polymerization extruder would be much more desirable as outlined by the advantages mentioned above.

The objective of this invention is to provide a continuous process for preparing absorbable polymers in an extruder and processing them directly into absorbable articles without additional melt processing and therefore, providing superior properties of the articles for surgical or medical applications. The continuous process also eliminates the middle steps of all material handling processes and the analytical work of a conventional batch process. The continuous process according to the invention is characterized in that continuous polymerization is conducted in an extruder, single or twin, having single or multiple additional and venting ports, coupled with a melt pump if desired, by continuous feed of mixtures of monomers or prepolymers or oligamers, catalysts, initiators and if appropriate, any other auxiliary agents, such as plasticizers, coloring agents; the extruded absorbable polymers are then processed into oriented parts or directly molded into parts of desired shapes and sizes in a continuous manner. Venting ports on the extruder are designed at various stages of the polymerization to remove un-reacted monomers and volatiles if necessary.

According to the invention, venting ports may be used at various stages of polymerization and processing to remove un-reacted monomers or other volatiles to achieve better quality of the absorbable articles.

According to the invention, the feed system of the reaction mixtures comprises an additional hopper or multiple additional hoppers for feeding various reaction mixtures at different stages in which the monomers, catalysts and other auxiliary agents are homogeneously mixed. The reaction mixtures are charged to the extruder via a conveyor system. Heated hoppers can also be used if melt reaction mixtures are required.

According to the invention, the feed system, the extruder, melt pump and the mold comprise devices under which an inert atmosphere is maintained using nitrogen or argon for carrying out the polymerization in the absence of moisture.

According to the invention, the temperature control elements and the rotation speed of the extruder are critical for achieving optimal results of the absorbable articles and their output. The process condition was tuned for proper dwell time and temperature for the monomers to polymerize. A single monomer can be charged to produce homopolymers or mixtures of monomers for copolymers. In another embodiments of the process, block copolymers can be produced if monomers are charged in various stages using multiple additional ports on the extruder. In a further embodiment, preformed polymers or oligomers can also be used with additional monomers to prepare copolymers.

The continuous process according to the invention produces absorbable articles of homopolymers or copolymers, random or block, from, but not limited to, any one or the combination of the following monomers: glyolide, L-lactide, D-lactide, trimethylene carbonate, caprolactone and dioxanone. Suitable catalysts are known in the art, tin chloride or tin chloride hydrate and stannous octoate being preferred. Initiators are also known in the art, alkyl alcohols, alkyl diols, alkyl ether diols and hydorxy carboxylic acids being preferred. Coloring agents are also known in the art, D&C Violet #2 and D&C Green #6 dyes being preferred.

The absorbable articles produced according to the invention have very consistent chemical, physical and mechanical properties throughout the manufacturing process as the result of the continuous operation. Furthermore, the continuously prepared absorbable polymers do not undergo a second melt processing in contrast to the batch operation, where polymers have to be melt completely before being processed. The absorbable articles produced according to the invention have excellent viscosity and superior mechanical properties.

The production yield of the absorbable articles processed according to the invention is high. Once the parameters of the continuous process are set, the production can be continued without interruption. Depending on the size of the feeder of the reaction mixtures, the yield can be as high as over 90%. Once the addition of the reaction mixture in one feeder is completed, a new one can be easily switched-on.

The continuous process according to the invention eliminates all cumbersome preparation and cleaning work associated with the batch operation. Furthermore, some of very costly analytical work is also eliminated and the efficiency is therefore greatly improved.

The invention further relates to the use of the absorbable articles prepared by the continuous process for the manufacturing of surgical devices. The representative examples are listed hereinafter, but not limited to, bone pins, screws, clamps, plates, anchors, vertebral discs, and stents.

### EXAMPLE 1

### Continuous Preparation of Absorbable Articles of Poly(L-Lactide)

A mixture of 5.0 kg of L-lactide and a solution of 8.0 g of lauryl alcohol, 9.0 g of D&C Violet No.2 dye and 1.2 g of tin chloride dihydrate in 150 ml of tetrahydrafuran was placed in an additional hopper in a homogeneous manner. After vacuum drying to remove the solvent, the reaction mixture was purged with nitrogen for 60 minutes with constant shaking. The mixture was then fed continuously into the additional port of a twin extruder having four heating zones under the protection of nitrogen. At the end of the zone 4 was connected with a die with a diameter of 6.0 mm. The temperature settings are listed in the following table:

| Add. Port | Zone 1 | Zone 2 | Zone 3 | Zone 4 | Die |
|---|---|---|---|---|---|
| Cold water | 100° C. | 185° C. | 190° C. | 185° C. | 175° C. |

The rotational speed of the extruder was maintained at 20 revolutions per minutes and the extruded rod so obtained was oriented by stretching it through a heated die with a draw ratio of 4. The oriented rod (diameter of 3 mm) was next annealed by placing it in an oven heated at 100° C. under vacuum for 12 hours.

### EXAMPLE 2

### Continuous Preparation of Absorbable Articles of Poly(Glycolide/L-Lactide) by Injection Molding

A mixture of 0.5 kg of glycolide and 2.0 kg of L-lactide and a solution of 6.0 g of lauryl alcohol, 4.0 g of D&C Violet No.2 dye and 0.6 g of tin chloride dihydrate in 100 ml of tetrahydrafuran was placed in an additional hopper in a homogeneous manner. After vacuum drying to remove the solvent, the reaction mixture was purged with nitrogen for at 60 minutes with constant shaking. The mixture was then fed continuously into the additional port of the extruder of an injection molding machine equipped with an injection mold under the protection of nitrogen. The temperatures of the heating zones on the extruder were controlled to at 180° C.-210° C. to achieve optimal polymerization reaction. The absorbable polymer was then molded into parts under injection conditions of a cylinder temperature of 190° C.; a mold temperature of 100° C. and an injection pressure of 45 mPa. The molded parts were further annealed at 110° C. for 10 minutes.

What is claimed is:

1. A continuous process for the preparation of absorbable articles, wherein the polymerization is conducted in an extruder with temperature controls and the extruded absorbable polymers are then further processed by compressing, orienting or injection molding.

2. A preparation process according to claim 1, wherein a single monomer or mixture of monomers or preformed polymers and oligamers can be used to produce absorbable homopolymers, random or block absorbable copolymers.

3. A preparation process according to claim 2, wherein said monomers are cyclic monomers, comprising cyclic alpha-hydroxy-carboxlic acids, cyclic alkyl esters, cyclic alkyl carbonates and cyclic ester-ethers.

4. Surgical/medical devices manufactured from the absorbable articles of claim 1.
